(19) United States
(12) Patent Application Publication
(10) Pub. No.: US 2026/0316684 A1
(43) Pub. Date: Oct. 15, 2026

(54) MODULAR GEOMETRY-ADAPTIVE VEHICLE-MOUNTED PLATFORM SYSTEM

(71) Applicant: Harry Ernst Sorensen Midgley, Brackendale (CA)

(72) Inventor: Harry Ernst Sorensen Midgley, Brackendale (CA)

(21) Appl. No.: 19/636,630

(22) Filed: Apr. 1, 2026

Related U.S. Application Data
(63) Continuation-in-part of application No. 19/038,266, filed on Jan. 27, 2025, now Pat. No. 12,623,605.
(60) Provisional application No. 63/625,788, filed on Jan. 26, 2024.

(51) Int. Cl. B60R 3/00

(52) U.S. Cl. CPC B60R 3/007

(57) ABSTRACT

A continuation-in-part modular vehicle step system builds on a tool-less snap-on mounting foundation having a variable-profile lumen and interchangeable sleeves configured to adapt engagement with support members having circular, oval, polygonal, or irregular cross-sectional geometries. A collar assembly may be positioned within a mounting aperture to adjust engagement characteristics between the mounting interface and the support member, while an extendable bridge member may be configured to adjust spacing and orientation relative to multiple support members. An aperture reconfiguration mechanism may provide a selectable engagement configuration for retaining the step assembly on the support member. Modular step modules may be connected end-to-end or side-by-side via intermediate coupling members, and optional termination components or sealing elements may be provided. The system may be removably mounted without permanent modification to the vehicle and may permit modular expansion and adjustment of the stepping platform.

### CROSS-REFERENCE TO RELATED APPLICATION

This application is a continuation-in-part of U.S. patent application Ser. No. 19/038,266, the disclosure of which is incorporated by reference in its entirety. The present application discloses additional subject matter that constitutes new matter and is entitled only to the filing date of the present application. This new matter includes, without limitation, the geometry-adaptive foundation with variable-profile lumen, interchangeable sleeves, slack-reduction collar, telescoping bridge for inter-rail spacing and pitch adjustment, male-female interlocking interfaces, removable unifying body bridge, perimeter seals, end caps, and secondary aperture-reconfiguration lock-out mechanisms (eccentric cam, tapered wedge, and over-center latch).

These features are described herein as evolutionary improvements and refinements upon the basic snap-on step disclosed in the parent application.

### FIELD OF THE INVENTION

The present invention generally relates to modular vehicle-mounted accessory systems. More particularly, the present invention relates to snap-on mounting assemblies for rail-mounted steps and platforms that provide primarily tool-less installation, with optional secondary retention via mechanical clamping mechanisms (such as eccentric cams, tapered wedges, or over-center latches) for high-vibration environments, as well as adaptive fitment across variable rail geometries, and modular chaining capability.

### BACKGROUND OF THE INVENTION

Vehicles, such as trucks and off-road vehicles, are often positioned higher off the ground, making it challenging for some individuals to enter and exit the vehicle or access its roof top storage devices. Various solutions have been developed, including fixed steps, retractable steps, and aftermarket step accessories. However, these solutions often present significant drawbacks:

While prior snap-on designs rely on fixed geometry and snap-fit engagement for retention, the present invention introduces additional mechanisms (eccentric cams, over-center latches, clamshell clamps) that actively adjust the mounting interface for secure, tool-less primary hold—eliminating loose fit and vibration failure without traditional fasteners.

Conventional Step Limitations: Many existing steps are positionally restrained, preventing user adjustability, and present field obstructions which prevent passage over or past certain obstacles. These designs are often restrictive to users' needs, particularly in off-road environments. Additionally, installation of these steps and platforms often require drilling, welding, bolting or other permanent modifications to the vehicle's body or frame. Such modifications may be undesirable for vehicle owners or leaseholders who want to preserve the vehicle's original condition, or deploy a more ergonomic, convenient, and field adaptable solution.

Snap-On and Variable-Position Approaches: More recent approaches, such as snap-on couplers disclosed in the prior art (e.g., U.S. patent application Ser. No. 19/038,266), address some limitations by providing primarily tool-less, hardware-free mounting and variable-position flexibility. However, these prior approaches are limited in two critical respects:
1. Prior snap-on designs often lack tool-less, fastener free, secondary retention methods—relying on elastic deflection or secondary retentive fasteners. These can loosen under extreme loads or vibration without mechanical clamping, or require one to semi-permanently install, requiring the addition of a tool set to one's vehicle outfitting for field adjustability/removal.
2. Inability to Modularize: Existing approaches do not chain or combine multiple step units into extended running boards or multi-tier platforms without custom fabrication or vehicle-specific brackets. Each step unit is a standalone assembly, limiting flexibility for users who desire easily adaptable sizing step access solutions.

Accordingly, there is a need for an improved vehicle step system, that is easy to install without requiring permanent modifications, adjustable in both height and pitch, capable of accommodating varying rail geometries, and designed to support modular chaining without custom fabrication.

These limitations are addressed in the present invention through aperture-reconfiguration mechanisms such as (eccentric cams, over-center latches, clamshell clamps) that deliver secure fastener-free, non-elastic primary hold, plus optional interlocking methods for seamless chaining. No custom work. Just adaptability.

### SUMMARY OF THE INVENTION

This continuation-in-part extends U.S. patent application Ser. No. 19/038,266 by introducing aperture-reconfiguration mechanisms—eccentric cams, over-center latches, clamshell clamps—for secure, fastener-free primary hold that eliminates vibration play without elastic deflection. The geometry-adaptive foundation maintains tool-less snap-on installation, with interchangeable sleeves, slack-reduction collars, and a telescoping bridge to fit any rail profile, spacing, or pitch. Modularity allows direct male-female chaining of step modules, bridged unification for same-gender pairs, perimeter seals, end caps, and load-bearing joints—all without custom fabrication.

### BRIEF DESCRIPTION OF THE DRAWINGS

### [Parent Application] Parent Application Drawings

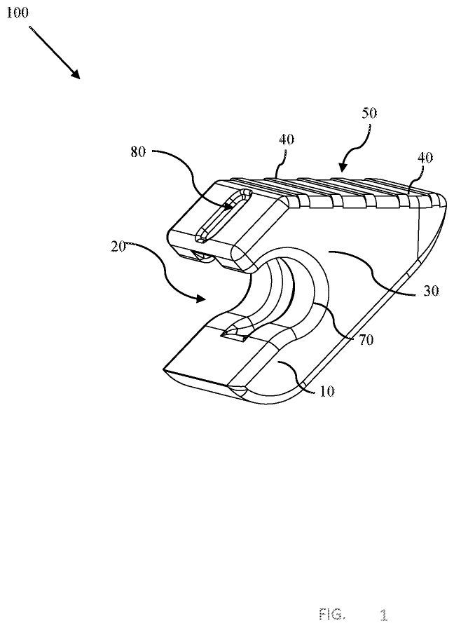

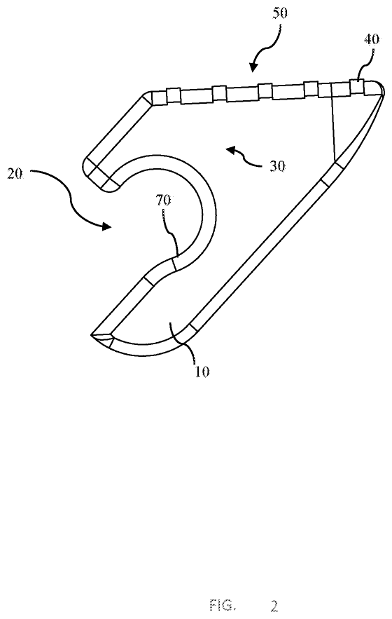

FIG. 1 Perspective view of a Generation 2 high-step for a Chevrolet Colorado ZR2, comprising a wedge-shaped body member having a platform surface including a plurality of ridges configured to provide traction, a vertical member extending between the platform surface and a rail engagement portion, and a contoured aperture formed in the rail engagement portion, wherein the rail engagement portion includes a recessed region formed within the aperture geometry and configured to modify friction, retention, or engagement characteristics with a vehicle rail.

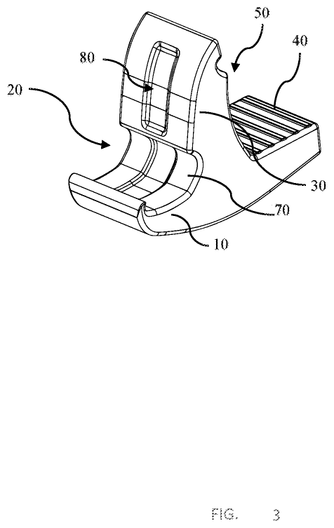

FIG. 2 Side view of a Generation 2 high-step for a Chevrolet Colorado ZR2, comprising a wedge-shaped body member having a platform surface, a vertical member extending downward from the platform surface and including a plurality of ridges, and a rail engagement portion including a contoured aperture, wherein the body member forms a cantilevered structure extending outward from the rail engagement portion.

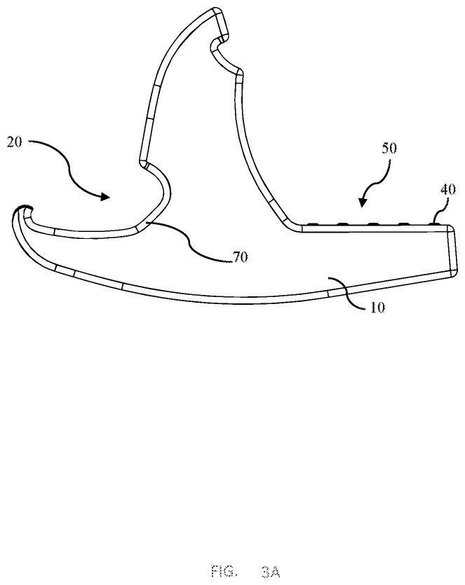

FIG. 3 Perspective view of a lowered step for a Generation 3 Chevrolet Colorado ZR2, comprising a body member having a platform surface including a plurality of ridges configured to provide traction, a rail engagement portion including a contoured aperture configured to capture a rail of a vehicle, and a vertical member extending upward from the body member, the vertical member being positioned to contact or bear against a second rail of the vehicle to provide stabilizing support.

FIG. 3A Side view of the lowered step of FIG. 3, comprising a body member having a rail engagement portion including a contoured aperture configured to capture a rail of a vehicle, and a vertical member extending upward from the body member, the vertical member being positioned to contact or bear against a second rail of the vehicle to provide stabilizing support.

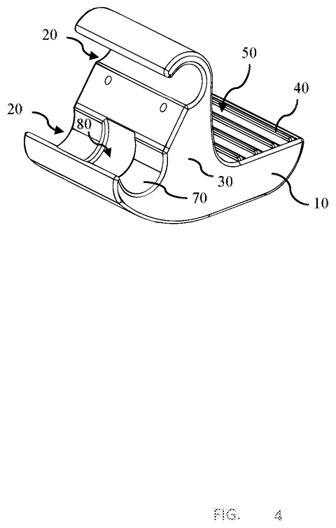

FIG. 4 Perspective view of a step device comprising a body member having a platform surface including a plurality of ridges configured to provide traction and dual rail engagement portions configured to capture respective rails and removably mount the step device without requiring tools or hardware, the body member further including a rear surface having a plurality of pre-formed openings configured to permit optional installation of secondary retention or securing elements.

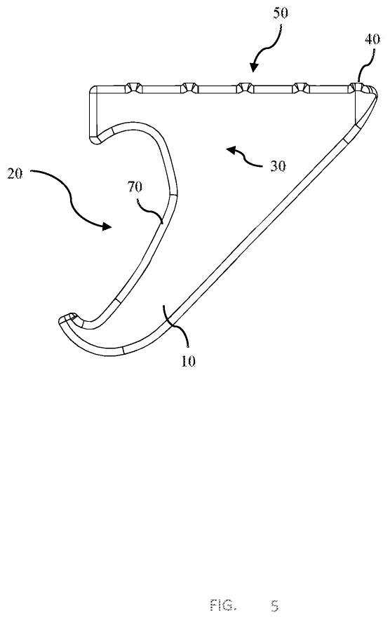

FIG. 5 Side view of a Generation 3 high-step for a Chevrolet Colorado ZR2, comprising a wedge-shaped body member having a platform surface including a plurality of ridges configured to provide traction, and a rail engagement portion including a contoured interface having multiple radii and a region of reduced curvature forming a near-planar segment within a chordal region, the rail engagement portion being configured for sequential hook-and-clip engagement with a rail or rail structure of the vehicle.

### [CIP New Matter] CIP Application Drawings

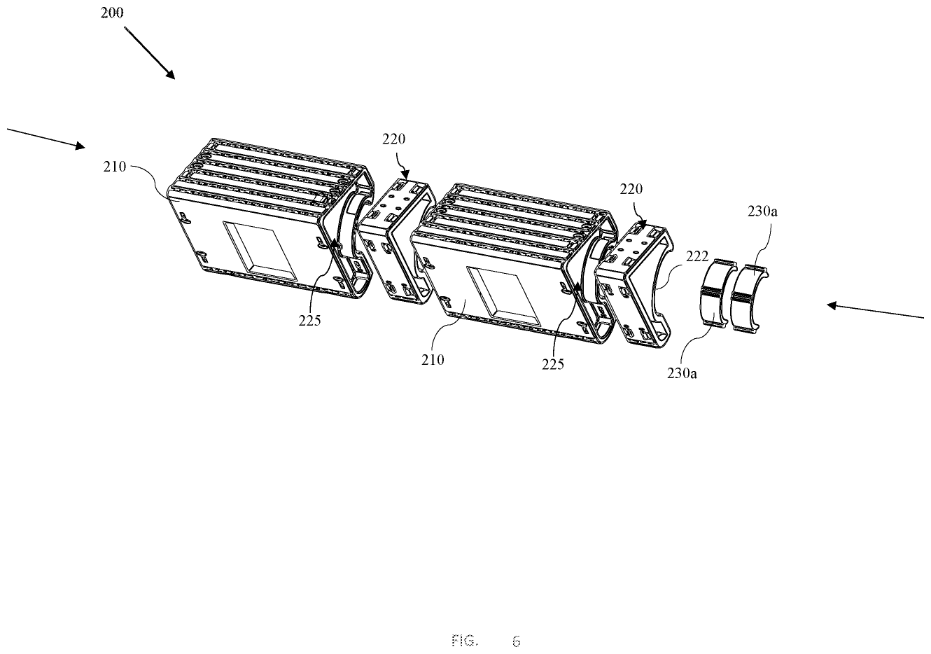

FIG. 6 Illustrates an exploded forward perspective view of a modular step system 200 comprising a plurality of step bodies 210 configured for cooperative connection using one or more unifying bodies 220, and further including removable collars 230a configured for insertion within mounting apertures 222 of the step bodies.

Each step body 210 includes a platform having traction features and structural recesses configured to reduce weight and maintain rigidity. The step bodies further include lateral receiving regions configured to accept unifying bodies or terminating components, and may include openings configured to receive optional secondary fasteners.

The unifying bodies 220 are configured as coupling members positioned between adjacent step bodies to permit modular chaining of multiple step bodies into an extended stepping surface. In some embodiments, the unifying bodies include integrated clip features and may include openings configured to receive optional secondary fasteners.

The collars 230a are configured as removable inserts receivable within the mounting apertures to modify engagement characteristics between the step bodies and a vehicle mounting structure, including adjustment of fitment, tolerance, or retention characteristics.

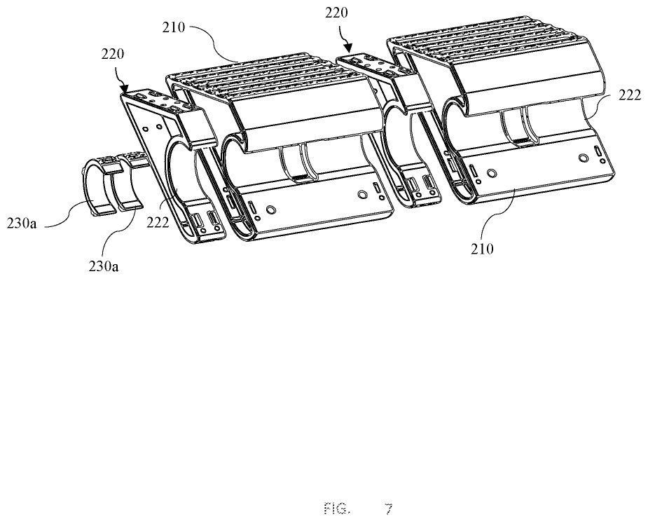

FIG. 7 Rear perspective of the chained modular step system from FIG. 6, highlighting the unifying body connections between adjacent step bodies, rear-facing mounting apertures, and removable collars configured for insertion therein to adjust fitment and engagement characteristics.

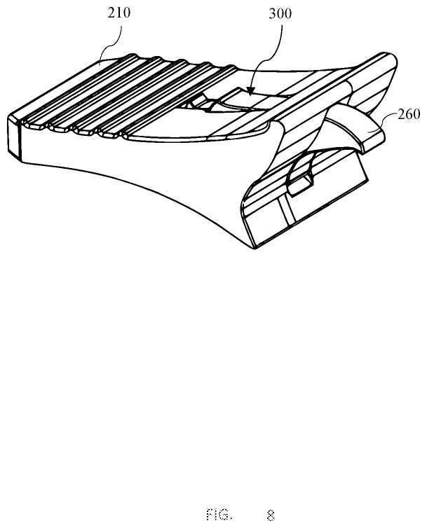

FIG. 8 Angled perspective of the lowered step for Silverado ZR2 Bison, showing an S-cam aperture-reconfiguration mechanism in a relaxed position defining a narrowed entry gap for insertion between upper and lower support members, the mechanism being configured to transition to an expanded engagement configuration for cooperation with a lower support member.

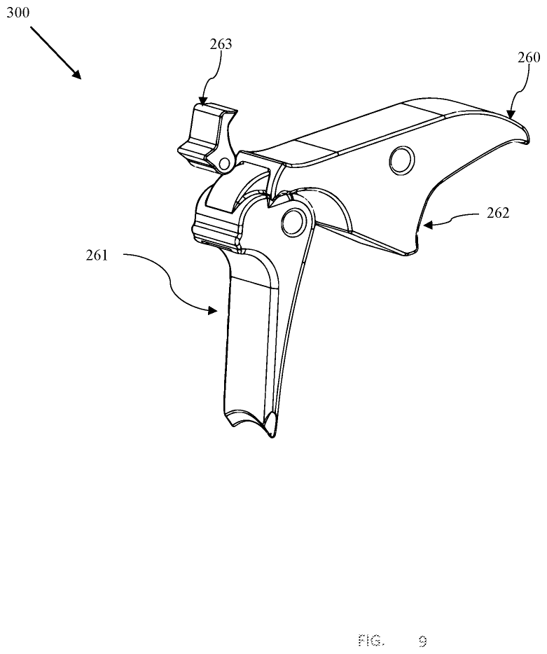

FIG. 9 Perspective close-up view of a collar assembly 300 illustrating an adjustable engagement mechanism including a pivoting cam member 262 and an actuating lever 263 configured to transition between insertion and retention configurations for selective engagement with a vehicle mounting structure, including cooperation with a support member 260.

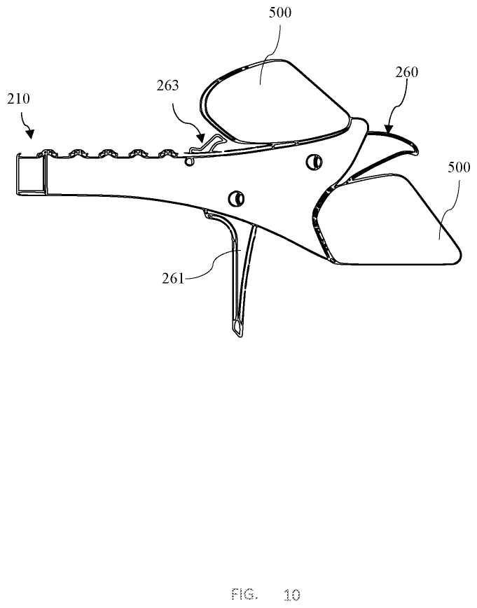

FIG. 10 Side elevation view of a footstep assembly illustrating an open engagement configuration in which opposing engagement regions define a narrowed entry geometry configured to permit insertion between spaced vehicle support members, with an actuating lever 263 positioned in a released configuration.

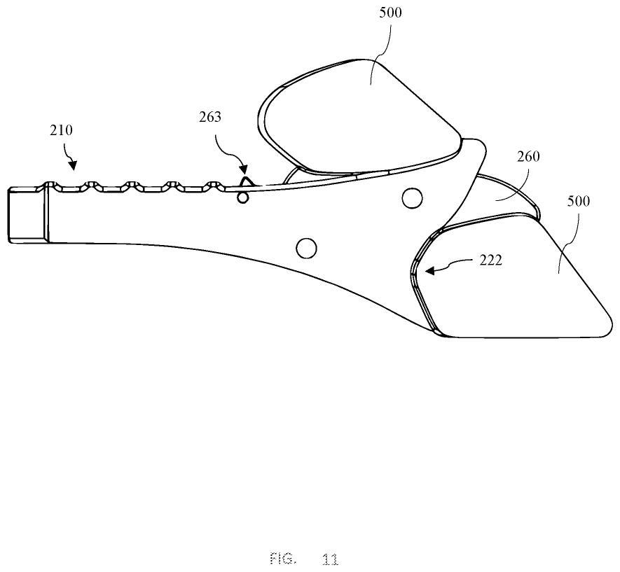

FIG. 11 Side elevation view of the footstep assembly illustrating a closed engagement configuration in which an engagement aperture 222 cooperates with a support member 261 to retain the assembly on a vehicle mounting structure, with an actuating lever 263 positioned in an engaged configuration.

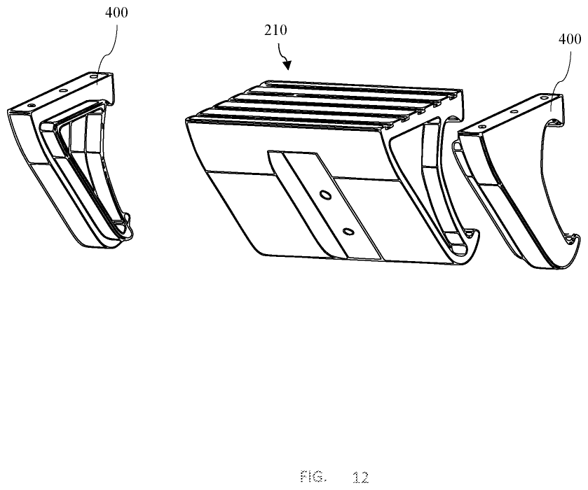

FIG. 12 Perspective view of terminating end components 400 positioned adjacent a modular step body 210, the end components being configured for attachment to opposing ends of the step body to provide termination, protection, and completion of the step assembly.

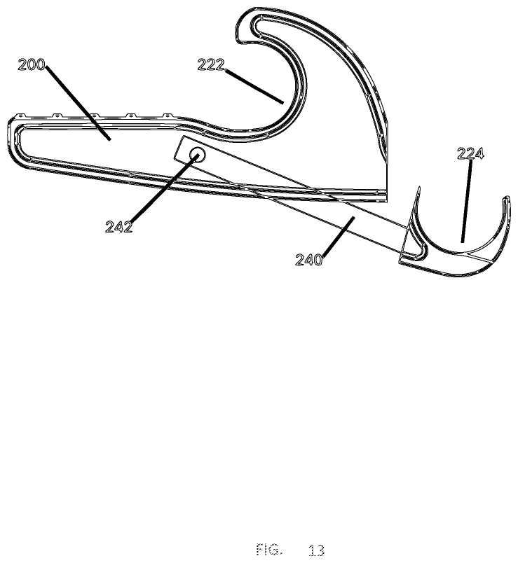

FIG. 13 Side elevation view of a step assembly illustrating a telescoping bridge arrangement including a primary aperture 222 and a secondary aperture 224 connected by an extendable arm member 240, the arm member being configured to move relative to the step body 200 to adjust spacing and angular orientation between the apertures, the arm member being coupled to the step body at pivot mechanism 242.

### DETAILED DESCRIPTION OF THE INVENTION

All illustrations of the drawings are for the purpose of describing selected versions of the present invention and are not intended to limit the scope of the present invention.

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features.

Furthermore, any embodiment discussed and identified as being “preferred” is considered to be part of a best mode contemplated for carrying out the embodiments of the present disclosure.

Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Additionally, it is important to note that each term used herein refers to that which an ordinary artisan would understand such a term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

[PARENT APPLICATION] The parent application (U.S. Ser. No. 19/038,266, incorporated by reference) discloses a tool-less snap-on mounting system for vehicle sidesteps, using elastic-deflection apertures for removably mounting on rock slider rails (FIGS. 1-5).

[CIP New Matter] Overview of the System Architecture (CIP Enhancement)

In some embodiments, the continuation-in-part disclosure provides a modular system architecture in which primary engagement with a vehicle support member is structurally separable from functional features of the step assembly through use of a geometry-adaptive mounting foundation. The mounting foundation may be configured to cooperate with interchangeable interface components, adjustable engagement mechanisms, extendable coupling members, and modular step modules to accommodate variation in support member geometry and spacing.

Such a modular architecture may permit selective adjustment of engagement characteristics, positioning, and connection between components of the step assembly while maintaining removable installation and compatibility across multiple configurations. The system components may operate in combination to facilitate modular expansion, positional adjustment, and cooperative engagement between adjacent modules.

### [CIP New Matter] the Geometry-Adaptive Foundation

In some embodiments, a mounting foundation 200 may be configured to engage a vehicle support member through mechanical interference or other engagement mechanisms to form a mounting interface for the step assembly. The mounting foundation may include an internal lumen or engagement region configured to accommodate support members having a variety of cross-sectional profiles, including circular, oval, polygonal, rectangular, or irregular geometries.

In certain configurations, the mounting foundation may include a structural body configured to contact the support member with a controlled engagement fit to position the step assembly relative to the support member and to reduce unintended relative movement during use. The mounting foundation may be compatible with interchangeable interface components or sleeves configured to adapt the engagement region to different support member geometries without requiring modification to the primary structure of the step body.

[CIP New Matter] Interchangeable Sleeves for Diameter and Profile Adaptation

In some embodiments, the mounting foundation may include one or more interchangeable sleeve components having selected internal geometries configured to engage support members of differing diameters or cross-sectional profiles. Each sleeve may be receivable within a mounting region of the step body to adapt a standardized mounting interface of the step body to a variety of support member configurations without modification to the step body itself.

The sleeve components may be removable and replaceable to permit selection of an appropriate interface geometry for a particular support member. In certain configurations, the sleeve components may include internal surfaces configured to conform to circular, non-circular, or irregular cross-sectional profiles.

Such interchangeable sleeve arrangements may permit use of a common step body across multiple support member configurations while maintaining compatibility with a standardized mounting interface.

[CIP New Matter] Slack-Reduction Collar for Zero-Play Fit

In some embodiments, a replaceable collar 300 may be positioned within a mounting aperture of the step body (see, e.g., FIGS. 9-10). The collar may be configured to engage an adjacent support member to adjust engagement characteristics between the step body and the support member.

In certain configurations, the collar may include a compressible or expandable structure, such as a split ring, wedge element, or other adjustable interface component, configured to apply contact pressure between the aperture region and the support member. Such contact pressure may reduce relative movement between the components during use.

In some embodiments, the collar may be removable and replaceable to permit adjustment of fitment characteristics, accommodation of dimensional variation, or adaptation to different operating conditions, while maintaining removable installation of the step assembly.

### [CIP New Matter] Telescoping Bridge for Inter-Rail Spacing and Pitch Adjustment

In some embodiments, a coupling assembly may include an extendable bridge member configured to span between multiple vehicle support members. The bridge member may include a primary body and one or more extendable portions configured for relative movement to adjust the effective length of the bridge member.

The extendable portions may be positionable to accommodate variations in spacing between support members and to permit adjustment of the orientation or pitch of the step body relative to the support members. In certain configurations, a retaining element, such as a locking pin or other releasable securing member, may be provided to maintain the selected extension position.

Such an extendable bridge arrangement may permit selective positioning of the step assembly relative to multiple support members while maintaining removable installation and compatibility with modular components of the system.

### [CIP NEW MATTER] Secondary Mechanical Lock-Out Via Aperture Reconfiguration

In some embodiments, a collar assembly 300 may include an adjustable engagement mechanism positioned within an aperture of the step body and configured to interact with a vehicle support member during installation. The mechanism may include a cam element configured to move relative to the aperture to adjust engagement characteristics between the step body and the support member.

In certain configurations, relative movement of the step body toward the support member may cause the cam element to transition between insertion and engagement configurations, thereby increasing contact between the aperture region and the support member. An actuating lever may be provided to position or preload the cam element prior to engagement, and a retaining element, such as a rotation lock 263, may be configured to maintain the selected engagement configuration until intentionally released.

In some embodiments, optional interface elements, such as compressible inserts or shims, may be positioned within the aperture region to accommodate dimensional variation, vibration, or wear of the support member. Such elements may permit adjustment of engagement characteristics while maintaining removable installation of the step assembly.

The aperture reconfiguration mechanism may operate independently of other adjustment mechanisms of the assembly and may be configured to provide supplemental retention or positional stability for the step body when engaged with the support member.

### [CIP New Matter] Modular Interlocking Interfaces

In some embodiments, each step module may include interface regions positioned at opposing ends of the module, such as recesses or receiving features configured to permit connection of adjacent modules using an intermediate coupling component. A unifying body may be configured as an intermediate connector having complementary engagement features receivable within corresponding recesses of adjacent step modules to permit end-to-end connection of the modules into an extended stepping surface.

In certain configurations, a plurality of step modules may be connected in sequence to form a continuous or expanded stepping surface, including arrangements comprising two or more modules. Such modular arrangements may permit formation of extended platforms or multi-level configurations using standardized components.

In alternative embodiments, step modules may include complementary engagement features, such as male and female interface elements, configured for direct connection between adjacent modules. In some implementations, use of an intermediate unifying body between similar interface regions may facilitate modular compatibility across multiple module configurations while reducing the need for module-specific connector variations.

The interlocking interfaces may be configured to position connected modules in cooperative alignment relative to a shared mounting structure, thereby promoting consistent positioning between adjacent modules while permitting modular assembly and disassembly.

[CIP New Matter] Removable Unifying Body Bridge

In some embodiments, adjacent step modules may include similar interface geometries, such as opposing recesses or receiving regions, that are not directly connectable without an intermediate coupling component. A removable unifying body may be provided as an intermediate connector configured to engage corresponding interfaces of adjacent step modules to permit end-to-end connection of the modules into an extended stepping surface.

The unifying body may include complementary engagement features configured for insertion into the receiving regions of the step modules without requiring specialized tools. In some embodiments, the unifying body may be removably retained within the receiving regions through interference fit, clip engagement, frictional engagement, or other retention mechanisms.

Additionally, one or more lateral recesses or channels formed in the step bodies may be configured to receive the unifying body in an alternative orientation to permit side-by-side positioning of adjacent step modules. This arrangement may enable formation of a wider platform while maintaining consistent alignment between the modules.

Use of a removable unifying body may permit modular expansion of the step system in multiple directions while reducing the need for module-specific connector variations. In some embodiments, standardized interface geometries may facilitate consistent positioning and cooperative engagement between connected modules.

### [CIP New Matter] Terminating End Caps

In some embodiments, terminating end components 400 may be configured for attachment to exposed interface regions of a modular step assembly, such as at terminal ends of a chain of interconnected step modules (see, e.g., FIG. 12). The terminating end components may be removably coupled to the step bodies to cover or complete exposed interface regions and to provide a finished termination of the assembly.

The terminating end components may include one or more surface features, markings, or design elements configured to provide identification, branding, or customization. In certain embodiments, the terminating end components may be formed from materials having selected optical properties, including translucent or semi-transparent materials, to permit passage or diffusion of light from a light source positioned adjacent to or within the component.

The terminating end components may be configured for removable attachment using engagement mechanisms such as snap-fit connections, frictional engagement, clip engagement, or other releasable coupling arrangements. Removable attachment may permit replacement, customization, or modification of the terminating end components while maintaining compatibility with the modular step assembly.

### [CIP New Matter] Perimeter Seals

In some embodiments, one or more perimeter sealing elements may be positioned along mating surfaces of interlocking interfaces of the modular step assembly. The sealing elements may include elastomeric members such as gaskets, O-rings, compressible strips, or other resilient sealing components configured to be positioned between adjacent components of the assembly.

The sealing elements may be configured to contact opposing surfaces during assembly to form a localized barrier at the interface region. In certain embodiments, the sealing elements may be compressible to accommodate assembly and disassembly of the components while permitting removal of the assembly without the use of specialized tools.

In some configurations, the sealing elements may be removable or replaceable to facilitate maintenance, cleaning, or adaptation of the assembly to different operating environments.

### [CIP New Matter] Structural Load-Bearing Joints

In some embodiments, interlocking interfaces between adjacent step modules may form cooperative joints configured to maintain relative positioning and engagement between connected components during use. The interfaces may include overlapping engagement regions that permit distribution of loads across adjacent modules when force is applied to the assembly.

In certain configurations, the primary support for applied loads may be provided by the mounting engagement between the step body and the associated vehicle support structure. Intermediate coupling components, such as unifying bodies, may function primarily to maintain connection and positional alignment between adjacent modules, while still permitting modular assembly and disassembly.

The interlocking interfaces may be configured for removable engagement without requiring permanent fasteners, adhesives, or specialized tools, thereby preserving modularity while allowing the assembly to rely on the mounting engagement of the step body for structural support.

[CIP New Matter] System Advantages and Distinction from Prior Art

In some embodiments, the modular step system may include a geometry-adaptive mounting foundation in combination with interchangeable interface components, adjustable engagement mechanisms, extendable coupling members, and modular interlocking step modules. These components may be configured to accommodate variations in vehicle support structures while permitting modular expansion and adjustment of the step assembly.

In certain configurations, the system may include one or more interface components configured to adapt to different support member geometries without requiring permanent modification to the vehicle. Adjustable engagement mechanisms, such as collars or locking elements, may be configured to position or maintain engagement between the step assembly and the vehicle support structure.

The modular step modules may include cooperative interface regions configured to permit connection of adjacent modules in multiple orientations, including end-to-end or side-by-side arrangements. Such modular arrangements may permit formation of extended or widened stepping surfaces using standardized components.

In some embodiments, one or more components of the system may be configured for installation, removal, or adjustment without requiring permanent fasteners or vehicle modification. Adjustable coupling members may permit selective positioning of the step assembly relative to multiple support members or variable spacing configurations.

In contrast to certain known repositionable coupling systems, the present modular step system may integrate profile adaptation, adjustable engagement, and modular connection capabilities within a single coordinated assembly.

### [CIP New Matter] Non-Limiting Embodiments

The foregoing description illustrates principles and selected embodiments of the present invention. Dimensions, materials (e.g., aluminum, polymer, steel, composite materials, PETG-CF), manufacturing techniques, assembly methods, and support member profiles are provided for illustrative purposes only and are not intended to limit the scope of the invention.

The present invention is intended to encompass variations, adaptations, equivalent arrangements, and modifications that would be understood by one of ordinary skill in the relevant art, consistent with the scope of the claims and their equivalents.

What is claimed is:

1. A modular mounting assembly for a vehicle rail, comprising: a snap-on interference-fit mounting foundation configured to engage the vehicle rail, the foundation having a variable-profile internal lumen adapted to rails of varying diameters and cross-sectional profiles; a functional step body; and a standardized mounting interface between the foundation and step body, enabling tool-less attachment and detachment.

2. The assembly of claim 1, wherein the mounting foundation comprises interchangeable sleeves of varying internal geometries, each sleeve configured to match a specific rail profile and allow the standardized interface to engage without step body modification.

3. The assembly of claim 1, further comprising a replaceable slack-reduction collar within a mounting aperture of the step body, the collar configured to reduce axial and radial play between the interface and rail for vibration-resistant fit.

4. The assembly of claim 1, wherein for dual-rail configurations, the foundation includes an extendable reach bridge with sliding arms that manually extend from the primary step body, hook the secondary aperture to the second rail, and lock via a pin to adjust pitch without tools.

5. The assembly of claim 1, further comprising a secondary mechanical lock mechanism for preventing unintended disengagement, the lock comprising an aperture reconfiguration device that self-actuates on seating to compress the aperture walls against the rail for friction grip, with a rotation lock to block reversal.

6. The assembly of claim 5, wherein the reconfiguration device comprises an eccentric cam that rotates under load to tighten hold, the lever providing initial pre-load.

7. The assembly of claim 4, wherein the extendable reach bridge is manually adjustable and lockable without the use of tools.

8. The assembly of claim 1, wherein the variable-profile internal lumen is configured to accommodate rails having circular, oval, polygonal, or irregular cross-sectional geometries.

9. The assembly of claim 1, wherein the mounting foundation comprises a plurality of cooperating structural components configured to collectively form the snap-on interference-fit mounting foundation.

10. The assembly of claim 1, wherein the mounting foundation is formed from one or more materials selected from polymer, composite, or metallic materials 11. The assembly of claim 1, wherein engagement of the mounting foundation with the vehicle rail occurs through a sequential installation path involving a change in relative position between the foundation and the rail during installation.

12. The assembly of claim 5, wherein application of downward load to the functional step body increases compressive engagement between the aperture and the vehicle rail.

13. A modular interlocking step system, comprising: at least two step modules, each having female interlocking recesses on both ends; a male-male unifying body configured to snap into opposing recesses for end-to-end chaining, forming a joined end-to-end stepping surface.

14. The system of claim 13, wherein the unifying body also inserts laterally into side recesses of adjacent modules for side-by-side wider platforms.

15. The system of claim 13, further comprising terminating end caps that snap onto exposed interfaces, providing a finished termination and supporting optional backlighting via translucent material.

16. The system of claim 13, further comprising perimeter seals along mating surfaces to limit debris ingress into joints, while allowing easy cleaning.

17. The system of claim 13, wherein the interlocking recesses and unifying body maintain alignment under typical stepping loads, with incidental weight distribution when a foot spans modules-primary support from the mounted foundation.

18. The system of claim 13, wherein the unifying body is removably insertable and detachable without tools.

19. The system of claim 13, wherein the interlocking recesses are dimensioned according to a standardized interface geometry shared across multiple step modules.

20. The system of claim 13, wherein step modules are configured to be connected both end-to-end and side-by-side using the same unifying body.
